(19) United States
(12) Patent Application Publication
(10) Pub. No.: US 2026/0245415 A1
(43) Pub. Date: Aug. 20, 2026

(54) INFORMATION PROCESSING APPARATUS, INFORMATION PROCESSING METHOD, AND NON-TRANSITORY RECORDING MEDIUM

(71) Applicant: NEC Corporation, Tokyo (JP)

(72) Inventor: Yuta KUDO, Tokyo (JP)

(73) Assignee: NEC Corporation, Tokyo (JP)

(21) Appl. No.: 19/157,708

(22) PCT Filed: Feb. 21, 2023
(86) PCT No.: PCT/JP2023/006216

§ 371 Date: Aug. 19, 2025

(51) Int. Cl. G07C 9/00; G07C 9/15; G07C 9/37

(52) U.S. Cl. CPC G07C 9/00563; G07C 9/15; G07C 9/37

(57) ABSTRACT

An information processing apparatus including: a determination unit that determines a recognition method for a target in case of entering a second area adjacent to a first area, depending on whether a first biometric recognition using biometric information acquired from an image of the target in the first area is successful or not; and a notification unit that notifies the target before entering the second area of the recognition method for the target determined by the determination unit.

### TECHNICAL FIELD

This disclosure relates to the technical field of information processing apparatus, information processing methods, and recording media.

### BACKGROUND ART

Patent Literature 1 describes a technology that includes a first terminal capable of providing services using a biometric recognition function or a non-biometric recognition function, a second terminal capable of switching between the biometric recognition function and the non-biometric recognition function and capable of providing services using the biometric recognition function or the non-biometric recognition function, and a server device connected to the first terminal and multiple second terminals, the server device calculating a usage rate of the biometric recognition function in at least one or more first terminals and determining an operation mode of at least one or more of the multiple second terminals based on the calculated usage rate.

Patent Literature 2 describes a technology that automatically selects one user recognition method from multiple predetermined user recognition methods based on output from at least one of an imaging apparatus built into the electronic device, an acceleration sensor built into the electronic device, and a position detection device built into the electronic device, and performs user recognition using the selected user recognition method.

Patent Literature 3 describes a technology in which, based on the security level of a room or area, one recognition method or a combination of two or more recognition methods is determined as the recognition method to be executed by a mobile terminal device, recognition method information corresponding to the determined recognition method is transmitted to the mobile terminal device, recognition information obtained from the user when the mobile terminal device executes the recognition method corresponding to the recognition method information is received from the mobile terminal device, and whether or not to permit entry to or exit from the room or area is determined depending on the result of verifying the recognition information.

### CITATION LIST

### Patent Literature

Patent Literature 1: WO2021/130948A1
Patent Literature 2: WO2018/128047A1
Patent Literature 1: JP2015-064722A

### SUMMARY

It is an example object of this disclosure to provide an information processing apparatus, an information processing method, and a recording medium that are intended to improve the techniques/technologies disclosed in Citation List.

### Solution to Problem

An information processing apparatus according to an example aspect includes: a determination unit that determines a recognition method for a target in case of entering a second area adjacent to a first area, depending on whether a first biometric recognition using biometric information acquired from an image of the target in the first area is successful or not; and a notification unit that notifies the target before entering the second area of the recognition method for the target determined by the determination unit.

An information processing method according to an example aspect includes: determining a recognition method for a target in case of entering a second area adjacent to a first area, depending on whether a first biometric recognition using biometric information acquired from an image of the target in the first area is successful or not; and notifying the target before entering the second area of the recognition method for the target determined.

A recording medium according to an example aspect is a recording medium on which a computer program that allows a computer to execute an information processing method is recorded, the information processing method including: determining a recognition method for a target in case of entering a second area adjacent to a first area, depending on whether a first biometric recognition using biometric information acquired from an image of the target in the first area is successful or not; and notifying the target before entering the second area of the recognition method for the target determined.

### BRIEF DESCRIPTION OF DRAWINGS

FIG. 1 is a block diagram illustrating a configuration of an information processing apparatus according to this disclosure.

FIG. 2 is a conceptual diagram illustrating an information processing system according to this disclosure.

FIG. 3 is a block diagram illustrating a configuration of a gate apparatus according to this disclosure.

FIG. 4 is a flowchart illustrating a flow of an information processing operation of the gate apparatus according to this disclosure.

FIG. 5 is a conceptual diagram illustrating an information processing system according to this disclosure.

FIG. 6 is a block diagram illustrating a configuration of a gate apparatus according to this disclosure.

FIG. 7 is a diagram illustrating an example of a notification from the gate apparatus according to this disclosure.

FIG. 8 is a block diagram illustrating a configuration of a gate apparatus according to this disclosure.

FIG. 9 is an example of a screen display visually recognized by a staff. block diagram illustrating a configuration of an information processing apparatus according to this disclosure.

FIG. 10 is a conceptual diagram illustrating an information processing system according to this disclosure.

FIG. 11 is a block diagram illustrating a configuration of a gate apparatus according to this disclosure.

FIG. 12 is a block diagram illustrating a configuration of an information processing apparatus according to this disclosure.

### DESCRIPTION OF EXAMPLE EMBODIMENTS

The following describes embodiments of the information processing apparatus, the information processing method, and the recording medium with reference to the drawings.

### 1: First Example Embodiment

A first embodiment of an information processing apparatus, information processing method, and recording medium is described. The first embodiment of the information processing apparatus, information processing method, and recording medium will be described below using an information processing apparatus 1 to which the first embodiment of the information processing apparatus, information processing method, and recording medium is applied.

### [1-1: Configuration of the Information Processing Apparatus 1]

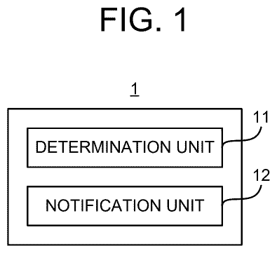

FIG. 1 is a block diagram showing the configuration of the information processing apparatus 1 according to the first embodiment. As shown in FIG. 1, the information processing apparatus 1 includes a determination unit 11 and a notification unit 12. The determination unit 11 determines whether to allow entry into a second area adjacent to a first area based on whether a biometrics recognition using biometric information of a target acquired from an image of the first area was successful. The notification unit 12 notifies the target attempting to enter the second area of the recognition method for the target determined by the determination unit 11.

### [1-2: Technical Effects of the Information Processing Apparatus 1]

The information processing apparatus 1 according to the first embodiment notifies the target of its own recognition method before the target enters the second area, so that the target knows in advance which recognition method will be used to recognize it and can prepare for recognition. This enables the information processing apparatus 1 to achieve smooth recognition.

### 2: Second Example Embodiment

Next, the second embodiment of the information processing apparatus, information processing method, and recording medium will be described. In the following, the second embodiment of the information processing apparatus, information processing method, and recording medium will be described using the information processing apparatus to which the second embodiment of the information processing apparatus, information processing method, and recording medium are applied. In the following, the information processing apparatus in this embodiment may be referred to as a gate apparatus.

### [2-1: Overview of the Gate Apparatus 2]

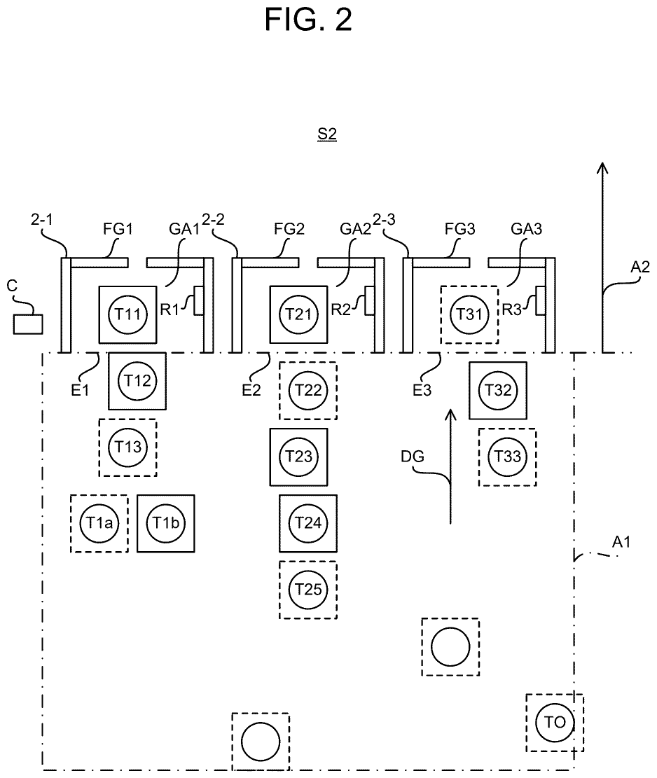

FIG. 2 is a conceptual diagram showing an application example of an information processing system S2 including a gate apparatus 2 according to the second embodiment. The information processing system S2 may be applied to an entrance to a restricted area, such as a boarding gate at an airport, a ticket gate at a railway station, an office, a theme park, or an event venue. The information processing system S2 may be applied to recognize a target person T to determine whether the target person T may enter the restricted area.

As shown in FIG. 2, the information processing system S2 may include multiple gate apparatus 2 (in FIG. 2, 2-1, 2-2, 2-3) and a camera C.

In FIG. 2, an area below each entrance E of each gate apparatus 2 is referred to as a first area A1, and an area above each entrance E of each gate apparatus 2 is referred to as a second area A2. The first area A1 and the second area A2 are adjacent to each other. Each gate apparatus 2 may be provided in the second area A2 as an entrance E to the second area A2. An entrance E to a gate area GA may also be the entrance E to the second area A2. An area within the gate apparatus 2 is referred to as the gate area GA.

The gate apparatus 2 may be an apparatus capable of controlling a passage of the target person T. The gate apparatus 2 may include a gate G capable of controlling the passage of the target person T. The target person T may be able to pass through the gate G included in any of the gate apparatus 2.

The second area A2 is the destination of the target person T and may be the restricted area accessible only the target person T who is recognized. For the target person T recognized, the gate G is opened, and the target person T may move from the first area A1 to the second area A2 through the gate G.

The gate G may be a flap gate, which is a plate-shaped member capable of controlling the passage of the target person T. The gate G may be a gate bar, which is a rod-shaped member capable of controlling the passage of the target person T. The gate apparatus 2 may control the gate G to be in an open state that allows the target person T to pass through the gate G in case recognition of the target person T is successful. On the other hand, the gate apparatus 2 may control the gate G to close so that the target person T cannot pass through the gate G in case recognition of the target person T fails.

Recognition information acquisition unit R is provided in each gate area GA. The recognition information acquisition unit R is a mechanism for acquiring information from the target person T for use in recognition. For example, in case the target person T is recognized by face recognition, the recognition information acquisition unit R may function as an imaging apparatus for capturing face images. In addition, in case of recognizing the target person T by iris recognition, the recognition information acquisition unit R may function as an imaging apparatus for capturing iris images. In this case, the imaging apparatus may be an infrared camera. Furthermore, in case of recognizing the target person T using a non-biometrics recognition other than the biometrics recognition, the recognition information acquisition unit R may function as a reader that reads recognition information other than the biometric information, such as codes. For example, the recognition information acquisition unit R may function as a reader that reads recognition information from a ticket with printed recognition information or an information processing terminal equipped with a display that shows recognition information.

The camera C captures the first area A1 and generates an area image. FIG. 2 illustrates an example where the camera C captures the entire first area A1, but the camera C may be provided for each gate apparatus 2.

In addition, there may be an information processing apparatus external to the gate apparatus for controlling each gate apparatus. In this case, the information processing system S2 may include the information processing apparatus, a plurality of gate apparatuses, and the camera C.

### [2-2: Configuration of the Gate Apparatus 2]

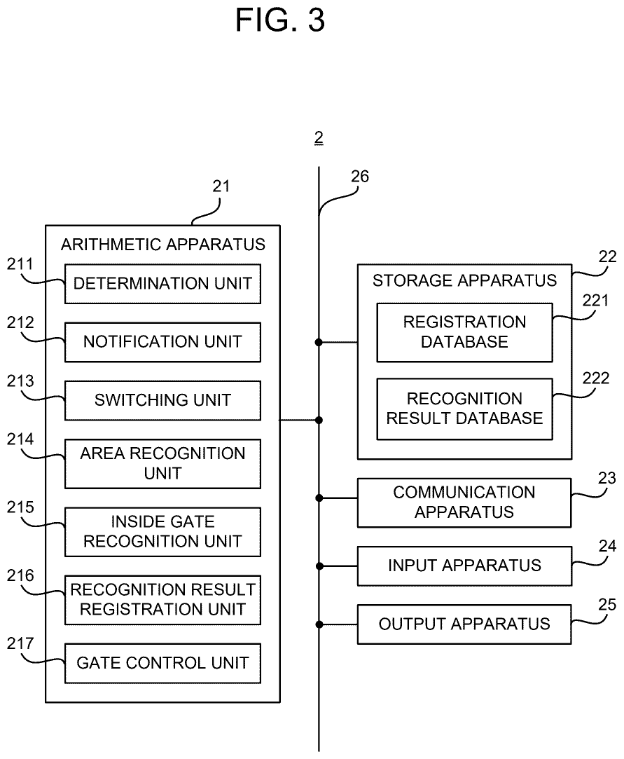

FIG. 3 is a block diagram showing the configuration of the gate apparatus 2 according to the second embodiment. As shown in FIG. 3, the gate apparatus 2 is provided with an arithmetic apparatus 21 and a storage apparatus 22. Furthermore, the gate apparatus 2 may include a communication apparatus 23, an input apparatus 24, and an output apparatus 25. However, the gate apparatus 2 may not include at least one of the communication apparatus 23, the input apparatus 24, and the output apparatus 25. The arithmetic apparatus 21, the storage apparatus 22, the communication apparatus 23, the input apparatus 24, and the output apparatus 25 may be connected via a data bus 26.

The arithmetic apparatus 21 may be, for example, a CPU (Central Processing Unit), a GPU (Graphics Processing Unit), and/or an FPGA (Field Programmable Gate Array). The arithmetic apparatus 21 reads a computer program. For example, the arithmetic apparatus 21 may read a computer program stored in the storage apparatus 22. For example, the arithmetic apparatus 21 may read a computer program stored in a computer-readable and non-temporary recording medium using a recording medium reading apparatus (e.g., the input apparatus 24 described later) provided in the gate apparatus 2. The arithmetic apparatus 21 may acquire (i.e., download or read) a computer program from an apparatus not shown, which is disposed outside the gate apparatus 2, via the communication apparatus 23 (or other communication apparatus). The arithmetic apparatus 21 executes the read computer program. As a result, logical functional blocks for executing the operations to be performed by the gate apparatus 2 are realized within the arithmetic apparatus 21. In other words, the arithmetic apparatus 21 functions as a controller for realizing logical functional blocks for executing the operations (i.e., processing) to be performed by the gate apparatus 2.

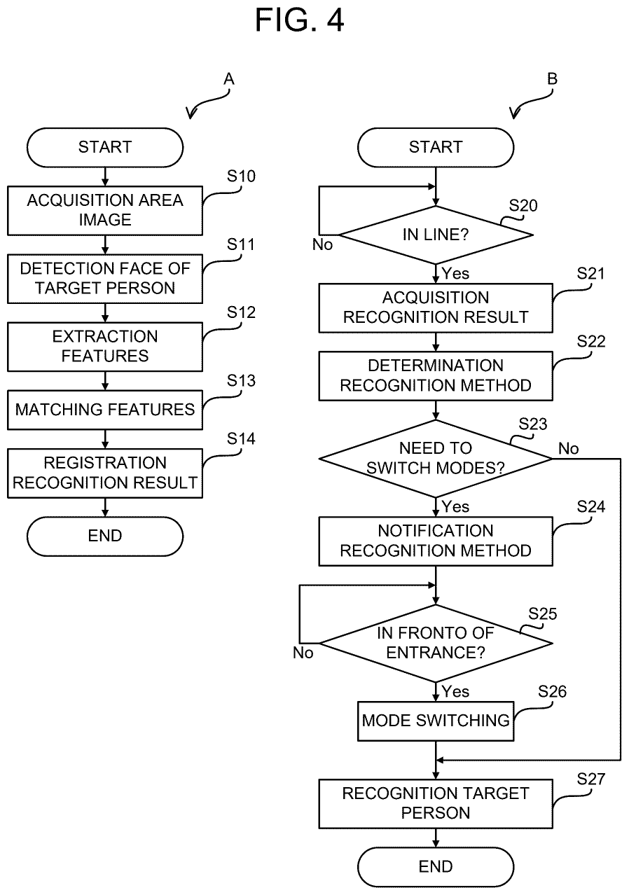

FIG. 3 illustrates an example of logical functional blocks realized within the arithmetic apparatus 21 for executing information processing operations. As shown in FIG. 3, the arithmetic apparatus 21 includes a determination unit 211, which is a specific example of the “determination unit” described in the Supplementary Note described later, a notification unit 212, which is a specific example of the “notification unit” described in the Supplementary Note described later, a switching unit 213, which is a specific example of the “switching unit” described in the Supplementary Note described later, an area recognition unit 214, an inside gate recognition unit 215, a recognition result registration unit 216, and a gate control unit 217 are realized. However, at least one of the switching unit 213, the area recognition unit 214, the inside gate recognition unit 215, the recognition result registration unit 216, and the gate control unit 217 may be realized outside the arithmetic apparatus 21. The details of the operations of the determination unit 211, the notification unit 212, the switching unit 213, the area recognition unit 214, the inside gate recognition unit 215, the recognition result registration unit 216, and the gate control unit 217 will be explained later with reference to FIG. 4.

The storage apparatus 22 is capable of storing desired data. For example, the storage apparatus 22 may temporarily store the computer program executed by the arithmetic apparatus 21. The storage apparatus 22 may temporarily store data temporarily used by the arithmetic apparatus 21 in case the arithmetic apparatus 21 is executing the computer program. The storage apparatus 22 may store data that the gate apparatus 2 stores for long-term preservation. Note that the storage apparatus 22 may be RAM (Random Access Memory), ROM (Read Only Memory), a hard disk apparatus, an optical magnetic disk apparatus, an SSD (Solid State Drive), and a disk array apparatus. In other words, the storage apparatus 22 may include a non-temporary recording medium. The storage apparatus 22 may include a registration database 221 and a recognition result database 222.

The communication apparatus 23 is capable of communicating with an external apparatus of the gate apparatus 2 via a communication network (not shown). The communication apparatus 23 may be a communication interface based on standards such as Ethernet (registered trademark), Wi-Fi (registered trademark), Bluetooth (registered trademark), or USB (Universal Serial Bus).

The input apparatus 24 is an apparatus that accepts information input to the gate apparatus 2 from outside the gate apparatus 2. For example, the input apparatus 24 may include an operation apparatus (e.g., at least one of a keyboard, a mouse, and a touch panel) that can be operated by an operator of the gate apparatus 2. For example, the input apparatus 24 may include a reading apparatus capable of reading information recorded as data on a recording medium that can be attached to the gate apparatus 2.

The output apparatus 25 is an apparatus that outputs information to the outside of the gate apparatus 2. For example, the output apparatus 25 may output information as images. In other words, the output apparatus 25 may include a display apparatus (a so-called display) capable of displaying images indicating the information to be output. For example, the output apparatus 25 may output information as voice. In other words, the output apparatus 25 may include a voice apparatus (a so-called speaker) capable of outputting voice. For example, the output apparatus 25 may output information onto paper. In other words, the output apparatus 25 may include a printing apparatus (a so-called printer) capable of printing desired information onto paper.

### [2-3: Information Processing Operations Performed by the Gate Apparatus 2]

The information processing operations performed by the gate apparatus 2 are described below. FIG. 4 is a flowchart showing the flow of information processing operations performed by the gate apparatus 2. Flowchart A in FIG. 4 shows the flow of an area recognition operation for the target person T related to the first area A1, and flowchart B in FIG. 4 shows the flow of an inside gate recognition operation for the target person T related to the gate area GA. The area recognition may be an operation performed to determine the recognition method of an inside gate recognition. The recognition method of the inside gate recognition includes the biometrics recognition, which recognizes the target person T using the biometric information, and the non-biometrics recognition, which recognizes the target person T using recognition information other than the biometric information.

The operations from “Start” to “End” shown in the flowchart A of FIG. 4 may be operations related to a single area image. For example, in case the camera C is capturing video, the operations from ‘Start’ to “End” shown in the flowchart A of FIG. 4 may be operations for each frame. As shown in flowchart A of FIG. 4, the area recognition unit 214 acquires the area image that captures the first area A1 (step S10). The area recognition unit 214 may acquire the area image that captures the first area A1 via the communication apparatus 23. The area recognition is the biometrics recognition. The biometrics recognition may be face recognition using face images.

The area recognition unit 214 detects a face area of the target person T included in the area image (step S11). The area recognition unit 214 extracts features of the face from the image of the face area (step S12). The area recognition unit 214 recognizes the target person T by matching the features extracted in step S12 and features registered in the registration database 221 (step S13). The area recognition unit 214 performs a first biometrics recognition using the biometrics recognition of the target person T located in the first area A1. The recognition result registration unit 216 registers a recognition result of the target person T in the recognition result database 222 (step S14). The operations from step S11 to step S14 are performed for each target person T included in the area image.

The operations from step S10 to step S13 shown in the flowchart A of FIG. 4 are repeated. Specifically, (1) the operations may be repeated until the target person T exits the first area A1. (2) The operations may be repeated a predetermined number of times for the target person T. (3) The operations may be repeated for a predetermined period of time for the target person T. After any one or more of (1) to (3) are completed, the success or failure of the first biometrics recognition may be determined. Depending on the determination of the success or failure of the recognition, the recognition method for the target person T in case of entering the second area A2 adjacent to the first area A1 may be determined. Additionally, even after determining the success or failure of the recognition, the target person T may be tracked until they exit the first area A1, regardless of whether the recognition was successful or failed. Furthermore, in case the target person T lines up in front of the entrance E, tracking of the target person T may be ended.

Furthermore, the target person T may be determined to be in one of the following three statuses: (i), (ii), or (iii), based on the success or failure of the first biometrics recognition and personal information. The personal information is information that can be referenced in case the first biometrics recognition is successful and an individual is identified. The personal information may include, for example, information related to an airline ticket in case the target person T is a passenger boarding an aircraft prior to the first biometrics recognition.
(i) Status where the first biometrics recognition was successful and the individual can pass through the gate G based on personal information
(ii) Status where the first biometrics recognition was successful but the individual cannot pass through the gate G based on personal information
(iii) Status where the first biometrics recognition failed

Note that even in case the target person T is registered, there may be cases where the biometrics recognition using the biometric information of the target person T fails at the first area A1 due to conditions such as poor health.

Additionally, the area recognition unit 214 may distinguish whether the target person T is the target of the area recognition related to the first area A1 based on the position of the target person T. For example, in case FIG. 2 illustrates the first area A1 as the first boarding gate of an airport, the area recognition unit 214 may determine that the target person TO who is in a position where they are likely to exit the first area A1 is a person recognized at a boarding gate other than the first boarding gate. In this case, the area recognition unit 214 may exclude the target person TO from the target of the area recognition related to the first area A1.

In addition, the operation shown in flowchart A in FIG. 4 may be performed by an apparatus external to the gate apparatus 2. In this case, since the recognition result database 222 is realized in an external apparatus, the operation of step S20 described later may be performed via the communication apparatus 23.

The operation from “Start” to “End” shown in flowchart B of FIG. 4 may be an operation related to a single target person T. Note that the gate apparatus 2 may perform operations related to a plurality of the target persons T in parallel.

As shown in flowchart B of FIG. 4, the determination unit 211 determines whether the target person T is lined up in front of the entrance E (step S20). The determination unit 211 is arranged in a vertical direction parallel to the direction of travel toward the gate G indicated by arrow DG in FIG. 2 (the direction from the first area A1 to the second area A2), and may determine that the target person T is lined up in case it is not arranged in a horizontal direction perpendicular to this direction of travel.

For example, in the case illustrated in FIG. 2, the determination unit 211 of the gate apparatus 2-1 may determine that the target person T12 and the target person T13 are lined up as the target person T. On the other hand, the determination unit 211 of the gate apparatus 2-1 need not determine that the target persons T1a and T1b are aligned as the target person T. Furthermore, the determination unit 211 of the gate apparatus 2-2 may determine that the target person T22, the target person T23, the target person T24, and the target person T25 are lined up as the target person T. Furthermore, the determination unit 211 of the gate apparatus 2-3 may determine that the target person T32 and the target person T33 are lined up as the target person T.

The determination unit 211 may determine that the target person is the target person T lined up from the entrance E up to a predetermined number of target persons T. In case the target person T is lined up in front of the entrance E (step S20: Yes), the determination unit 211 acquires the recognition result of the target person T registered in the recognition result database 222 (step S21).

Note that whether the area recognition of the target person T has failed may be determined, for example, in case it is determined that the target person has entered a specific gate area GA. In other words, the area recognition unit 214 may determine that the area recognition of the target person T has failed in case the target person has entered a specific gate area GA and the area recognition has not yet succeeded. Also, whether the area recognition of the target person T has failed or not may be determined in case it is determined that the target person T is lined up in front of the entrance E to any of the gate areas GA.

For example, in the case shown in FIG. 2, the target person T for which the area recognition has succeeded is enclosed by a solid line frame, and the target person T for which the area recognition has not succeeded is enclosed by a dotted line frame. For example, in case the determination unit 211 of the gate apparatus 2-1 determines that the target person T13 is the target person T, in case the area recognition of the target person T13 has not yet succeeded, the determination unit 211 may determine that the target person T13 failed the biometrics recognition in the first area A1.

The determination unit 211 determines the recognition method for the target person T in case of entering the second area A2 adjacent to the first area A1, based on whether the biometric recognition using the biometric information of the target person T in the first area A1 was successful or not (step S22).

In case the biometric recognition of the target person T in the first area A1 was successful, the inside gate recognition unit 215 recognizes the target person T entering the second area A2 using the biometric recognition. The recognition mode used for recognition by the biometrics recognition is referred to as a biometrics recognition mode. In the example shown in FIG. 2, the target person T enclosed by the solid line frame is recognized by the biometrics recognition, and the recognition mode used to recognize the target person T is understood to be the biometrics recognition mode.

In case the biometrics recognition of the target person T fails in the first area A1, the inside gate recognition unit 215 recognizes the target person T entering the second area A2 using the non-biometrics recognition. The recognition mode used for recognition by the non-biometrics recognition is referred to as a non-biometrics recognition mode. In the example shown in FIG. 2, the target person T enclosed in the dotted frame is recognized by the non-biometrics recognition, and the recognition mode in case of recognizing the target person T is understood to be the non-biometrics recognition mode. In the non-biometrics recognition mode, the non-biometrics recognition is performed using recognition information other than the biometric information. The non-biometrics recognition may include code recognition of codes that can be read from tickets or smartphone screens. Additionally, recognition of information stored in the IC chip of an IC card may be performed. The codes for code recognition may include two-dimensional codes, barcodes, etc. IC cards may include transportation IC cards, My Number cards, passports, driver's licenses, etc.

The determination unit 211 determines whether the recognition mode for identifying the target person T is the biometrics recognition mode or the non-biometrics recognition mode. The determination unit 211 determines the recognition mode for recognizing the target person T based on whether the target person T has successfully undergone the biometrics recognition related to the first area A1. In addition, the determination unit 211 determines whether the recognition mode for recognizing the target recognized before the target person T is the biometrics recognition mode or the non-biometrics recognition mode.

The switching unit 213 determines whether to switch the recognition mode based on the recognition mode that is set and the recognition method of the target person T (step S23). The switching unit 213 determines whether to switch the recognition mode by comparing the recognition mode of the target recognized before the target person T with the recognition mode of the target person T. In case the recognition mode of the target recognized before the target person T is the biometrics recognition mode and the target person T arriving at the second area A2 has not successfully completed the biometrics recognition related to the first area A1, the switching unit 213 determines that it is necessary to switch to the non-biometrics recognition mode. Or, in case the recognition mode of the target recognized before the target person T is the non-biometrics recognition mode and the target person T arriving at the second area A2 has successfully undergone the biometrics recognition related to the first area A1, the switching unit 213 determines that it is necessary to switch to the biometrics recognition mode. The switching unit 213 may determine whether it is necessary to switch the recognition mode by comparing the current recognition mode, i.e., the recognition mode of the target person T in the gate area GA, with the next recognition mode of the target person T in the inside gate recognition, i.e., the recognition mode of the target in front of the entrance E.

In case a switch in recognition mode is necessary (step S23: Yes), the notification unit 212 notifies the target person T arriving at the second area A2 of the recognition method of the target person T determined by the determination unit 211 (step S24). The notification unit 212 notifies the target person T arriving at the second area A2 of the recognition method for the target person T determined by the determination unit 211 in case the switching unit 213 switches from one of the biometrics recognition mode and the non-biometrics recognition mode to the other. The specific notification method by the notification unit 212 is described in the third to sixth embodiments. The notification unit 212 may notify the target person T of the recognition method using at least one notification method described in the third to sixth embodiments. The notification unit 212 may notify the target person T of the recognition method by combining multiple notification methods described in the third to sixth embodiments.

In the example shown in FIG. 2, since the recognition method for the target person T22 is different from that for the target person T21 and a recognition mode switch is required, the notification unit 212 notifies the target person T22 of the recognition method. Similarly, in case the recognition method for the target person T23 differs from that for the target person T22, requiring a mode switch, the notification unit 212 notifies the target person T23 of the recognition method. On the other hand, in case the recognition method for the target person T24 is the same as that for the target person T23 and no mode switch is required, the notification unit 212 does not need to notify the target person T24 of the recognition method. Furthermore, in case the recognition method for the target person T25 is different from that for the target person T24 and the mode switch is required, the notification unit 212 notifies the target person T25 of the recognition method.

In other words, the notification unit 212 determines a manner of notification of the recognition method based on whether or not the switching unit 213 determines that the recognition mode switch is necessary. For example, the notification unit 212 may change whether or not to notify the recognition method based on whether or not the switching unit 213 determines that the recognition mode switch is necessary. In other words, the notification unit 212 changes the display mode depending on whether the recognition mode is switched from the first recognition mode to the second recognition mode or not. That is, the notification unit 212 executes control to change the display mode depending on whether the recognition mode is switched or not, even in case the final recognition mode is the same.

The notification unit 212 emphasizes notifications in case the recognition mode switch is required, compared to in case it is not required. The notification unit 212 may emphasize notifications by, for example, increasing the number of notifications in case the recognition mode switch is required, compared to in case it is not required. Additionally, the notification unit 212 may change the timing of notifications depending on whether the recognition mode switch is required or not. The notification unit 212 may notify earlier in case the mode switch is required compared to in case the mode switch is not required. For example, the notification unit 212 may notify in case the target person T is at the front of the line in case the mode switch is not required, and notify in case the target person T is second from the front of the line in case the mode switch is required. In addition, the notification unit 212 may change the font, color, etc. of the text depending on whether the mode switch is required or not. The notification unit 212 may adopt fonts, colors, etc. that are more noticeable in case the mode switch is required compared to in case the mode switch is not required. The notification unit 212 may increase the number of notification methods used in case the mode switch is required compared to in case the mode switch is not required.

As described above, in case the target person T is determined to be in one of the three statuses (i), (ii), and (iii) based on the result of the first biometric recognition and personal information, a notification timing may be changed depending on which status it is. For example, in case the target person T is in status (ii), the notification unit 212 may notify the target person T at a timing when it is determined that they are lined up. In case the target person T with status (ii) lines up behind the target person T with status (i), it is not necessary to switch the recognition mode, but the notification unit 12 may notify the relevant target person T early. In case the target person T in status (ii) is triggered by being in a line, the notification unit 12 may notify the target person T in status (ii).

The determination unit 211 determines whether the target person T is in front of any entrance E (step S25). The determination unit 211 may determine whether the target person T is at the front of the line. The determination unit 211 may determine whether the recognition of the target recognized in front of the target person T has been completed.

In case the target person T is in front of any entrance E (Step S25: Yes), the switching unit 213 switches the recognition mode (Step S26). In case the target person T has not successfully completed the first biometrics recognition related to the first area A1, the switching unit 213 switches from the biometrics recognition mode to the non-biometrics recognition mode. Or, in case the target person T has successfully completed the first biometric recognition related to the first area A1, the switching unit 213 switches from the non-biometric recognition mode to the biometric recognition mode.

The inside gate recognition unit 215 recognizes the target person T (step S27). The inside gate recognition unit 215 uses the biometrics recognition engine in the biometrics recognition mode and the non-biometrics recognition engine in the non-biometrics recognition mode to recognize the target person T. In the biometrics recognition mode, the inside gate recognition unit 215 acquires the biometric information of the target person T from the recognition information acquisition unit R and performs the biometrics recognition. In the biometric recognition mode, the inside gate recognition unit 215 may perform face recognition again in the gate area GA. The recognition information acquisition unit R may capture an image with higher resolution than the image captured by the camera C, and the inside gate recognition unit 215 may perform face recognition with higher performance. In case the target person T has registered iris information, the recognition information acquisition unit R captures an iris image, and the inside gate recognition unit 215 may perform iris recognition. In the non-biometrics recognition mode, the inside gate recognition unit 215 acquires recognition information via the recognition information acquisition unit R and performs the non-biometrics recognition.

Even in case the recognition mode corresponding to the recognition method of the target person T is the same as the recognition mode that is set and no mode switch is required, in case the recognition method of the target person T is the non-biometrics recognition, the notification unit 212 may notify the target person T that the recognition method is the non-biometrics recognition. On the other hand, in case the recognition mode corresponding to the recognition mode that is set and the recognition method of the target person T is the same, no change in recognition mode is required, and the recognition method of the target person T is the biometrics recognition, the notification unit 212 may notify the target person T with a message such as “Please just pass through.” This allows for improved throughput.

Additionally, in case the target person T passes through the gate, the recognition information for the corresponding target person T registered in the recognition result database 222 may be deleted. Whether the target person T has passed through the gate may be determined by whether the target person T has left the first area A1. Even in case the target person T has not passed through the gate, in case the target person T is no longer present in the first area A1, the recognition information for the target person T registered in the recognition result database 222 may be deleted. In case the target person T has moved to another boarding gate, etc., the recognition information for the target person T registered in the recognition result database 222 may also be deleted.

### [2-4: Technical Effect of the Gate Apparatus 2]

For example, in case the gate apparatus that performs the biometrics recognition and the gate apparatus that performs the non-biometrics recognition are separate apparatuses, a long line may form in front of one gate apparatus, while the other gate apparatus remains empty. The gate apparatus 2 according to the second embodiment is capable of performing the biometric recognition and the non-biometric recognition according to the target person T. The gate apparatus 2 can switch in real time between recognizing the target person T that has successfully undergone the biometrics recognition using the biometrics recognition and recognizing the target using recognition information other than the biometric information for the target person T that has not successfully undergone the biometrics recognition. The gate apparatus 2 can switch the recognition mode according to the target person T, and in case the recognition mode is switched, it notifies the target person T of the recognition method, thereby enabling notification to be made to the target that requires notification.

### 3: Third Example Embodiment

Next, the third embodiment of the information processing apparatus, information processing method, and recording medium will be described. In the following, the third embodiment of the information processing apparatus, information processing method, and recording medium will be described using a gate apparatus 3 to which the third embodiment of the information processing apparatus, information processing method, and recording medium is applied.

### [3-1: Overview of the Gate Apparatus 3]

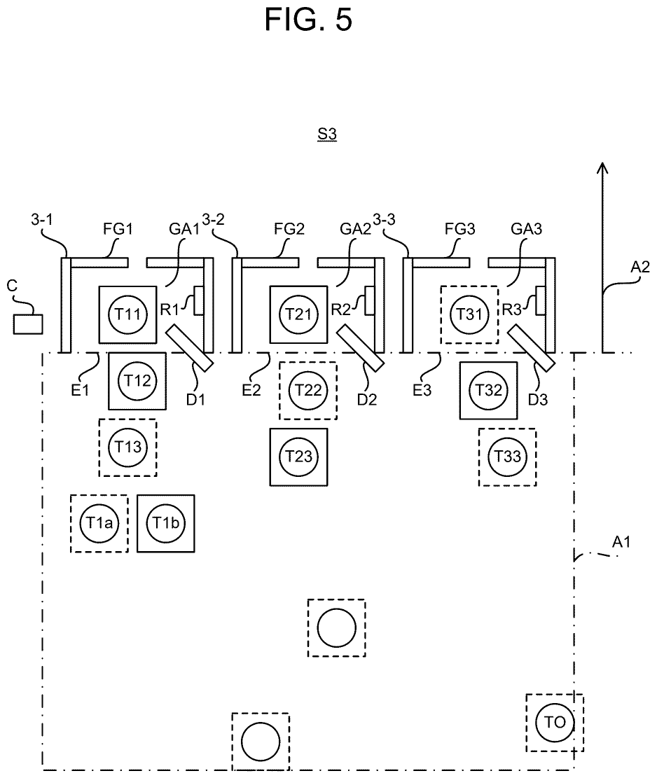

FIG. 5 is a conceptual diagram showing an application example of an information processing system S3 including the gate apparatus 3 according to the third embodiment. As shown in FIG. 5, the information processing system S3 includes displays D (D1, D2, and D3 in FIG. 5). The display D introduced in the third embodiment may be fixed in a fixed position. The display D may be provided for each gate apparatus 3. The display D may be provided, for example, at the entrance E. The display D may be provided at a location where it is easily visible to the target person T aligned with the entrance E in the gate area GA. That is, the display D may be provided at a position where it is easy to notify the recognition method to the target person T (e.g., the target person T12) who is next to be targeted to the inside gate recognition after the target person T (e.g., the target person T11) who is being targeted to the inside gate recognition.

### [3-2: Configuration of the Gate Apparatus 3]

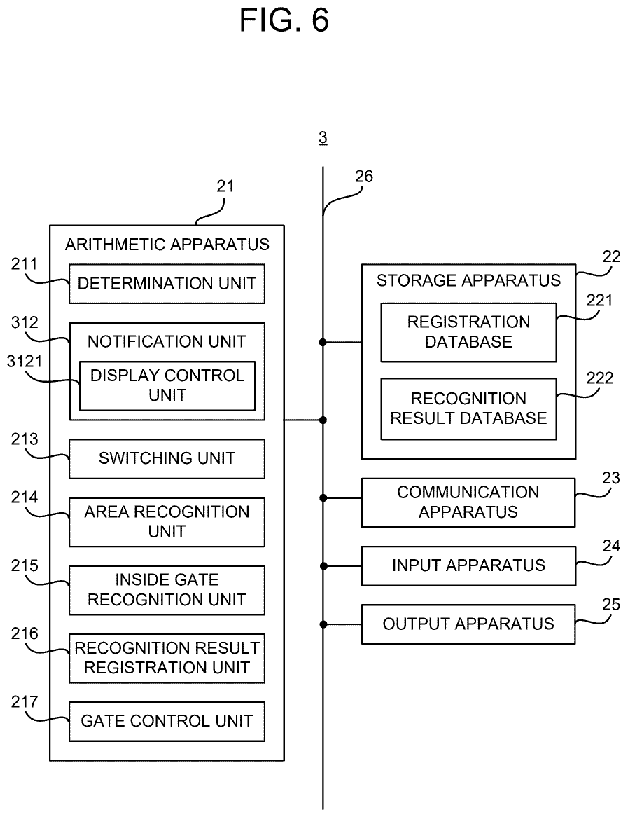

Referring to FIG. 6, the configuration of the gate apparatus 3 according to the third embodiment will be described. FIG. 6 is a block diagram showing the configuration of the gate apparatus 3 according to the third embodiment.

As shown in FIG. 6, the gate apparatus 3 according to the third embodiment differs from the gate apparatus 2 according to the second embodiment in that a notification unit 312 includes a display control unit 3121. The other features of the gate apparatus 3 may be the same as the other features of the gate apparatus 2. Therefore, in the following, the parts that differ from the embodiments already described will be explained in detail, and the other overlapping parts will be omitted as appropriate.

### [3-3: Information Processing Operation Performed by the Gate Apparatus 3]

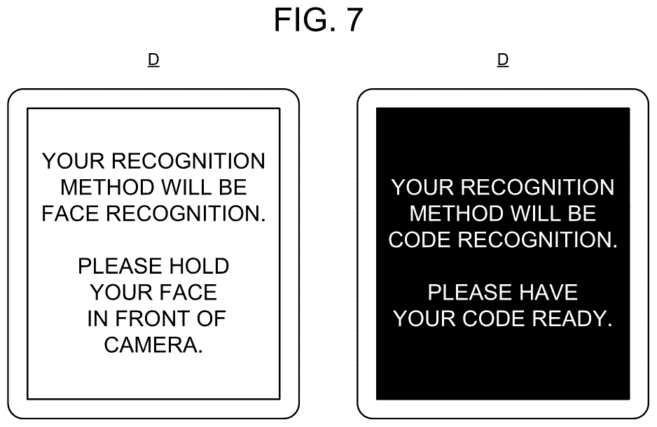

The display control unit 3121 displays the recognition method for the target person T determined by the determination unit 211 on the display D installed in the entrance area of the gate area GA, thereby notifying the target person T arriving at the gate area GA of the recognition method for the target person T. The display D always notifies the recognition method of the next target person T to be recognized, but may notify the change in the recognition method in a manner that makes the change more easily understandable at the timing when the recognition method changes. For example, as illustrated in FIG. 7, one may be displayed in black text on a white background, and the other in white text on a black background, so that the change in the recognition method is visually distinguishable.

### [3-4: Technical Effects of the Gate Apparatus 3]

The gate apparatus 3 according to the third embodiment notifies the target of the recognition method by displaying the recognition method on a display provided at the entrance to the second area before the target enters the second area, so that the target person can recognize his or her own recognition method.

### 4: Fourth Example Embodiment

Next, the fourth embodiment of the information processing apparatus, information processing method, and recording medium will be described. In the following, the fourth embodiment of the information processing apparatus, information processing method, and recording medium will be described using a gate apparatus 4 to which the fourth embodiment of the information processing apparatus, information processing method, and recording medium is applied.

### [4-1: Configuration of the Gate Apparatus 4]

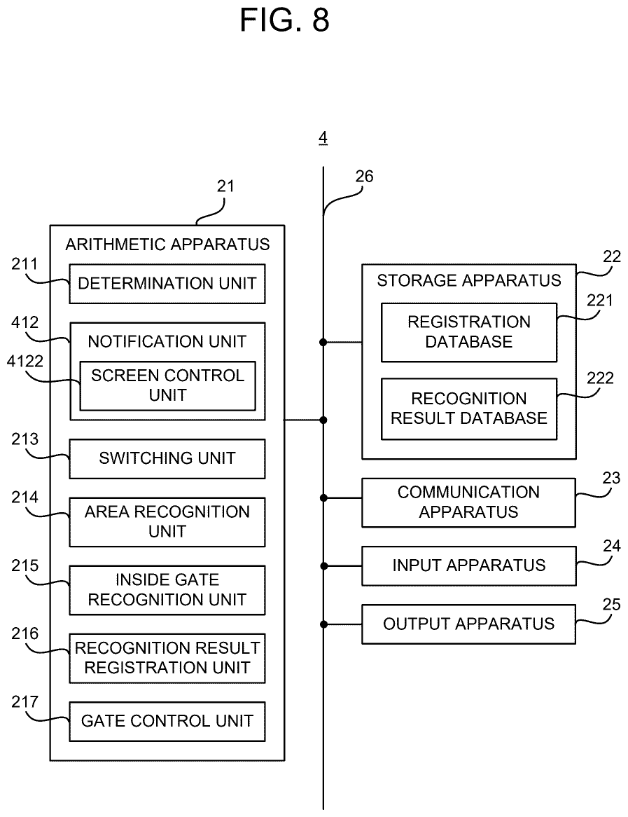

Referring to FIG. 8, the configuration of the gate apparatus 4 according to the fourth embodiment will be described. FIG. 8 is a block diagram showing the configuration of the gate apparatus 4 according to the fourth embodiment.

As shown in FIG. 8, the gate apparatus 4 according to the fourth embodiment differs from the gate apparatus 2 according to the second embodiment and the gate apparatus 3 according to the third embodiment in that a notification unit 412 includes a screen control unit 4122. Other features of the gate apparatus 4 may be the same as at least one other feature of the gate apparatus 2 and the gate apparatus 3. For this reason, the following description will explain in detail the parts that differ from the embodiments already described, and omit explanations of other overlapping parts as appropriate.

### [4-2: Example of a Screen Controlled by the Gate Apparatus 4]

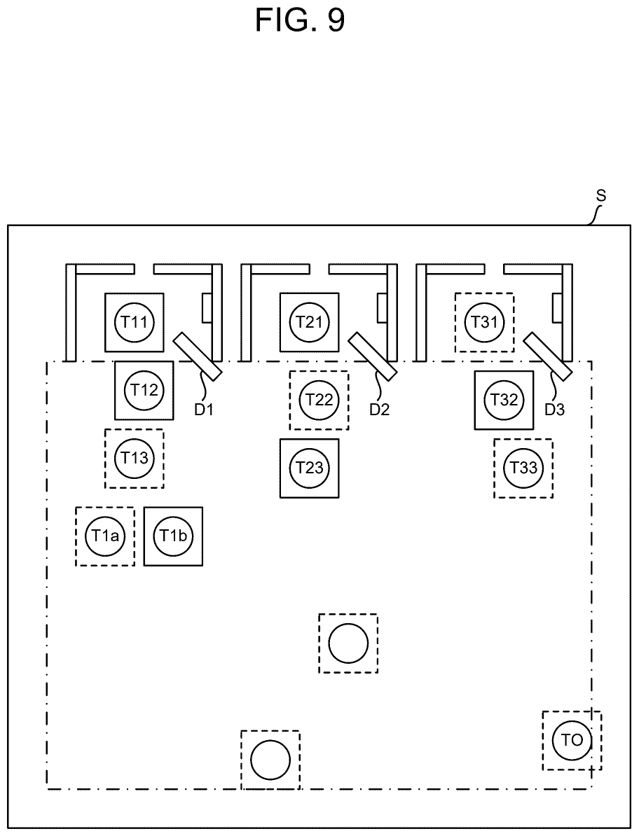

The notification unit 412 sends information indicating the recognition method for the target person T before entering the second area A2 to a staff waiting in the first area A1. The staff in the first area A1 may carry an information processing terminal capable of displaying a screen S on which the recognition method for the target person T in the first area A1 can be viewed. FIG. 9 shows an example of the display of the screen S of the information processing terminal carried by the staff. The screen control unit 4122 provided in the notification unit 412 may control the display of the screen S of the information processing terminal held by the staff. Specifically, the screen control unit 4122 may display information that enables the positions of each target person T and the recognition method to be visually confirmed on the screen S, as shown in FIG. 9. In addition, for example, in the fourth embodiment, in case the display D is provided at the entrance E as in the third embodiment, the screen control unit 4122 may cause the screen S to display information that can be seen by the staff indicating the position of each target person T and the recognition method as well as the positional relationship between each target person T and the display D. The staff may receive information indicating the recognition method for the target person T before entering the second area A2 from the gate apparatus 4 by viewing the screen S.

The staff may approach the target person T to whom the recognition method should be notified based on the information displayed on the screen S and notify the target person T of the recognition method. In addition, the staff may approach a target person T who appears to be in need of assistance based on the information displayed on the screen S.

In addition, for example, in case the display D is provided at the entrance E as in the third embodiment, the staff may wait at a position opposite the display D and prompt the target person T to look at the display D. Alternatively, the staff may notify the target person T of the recognition method via speech, gestures, etc., and prompt them to prepare for recognition.

### [4-3: Technical Effect of the Gate Apparatus 4]

The gate apparatus 4 according to the fourth embodiment can operate the staff in the first area A1 appropriately.

### 5: Fifth Example Embodiment

Next, the fifth embodiment of the information processing apparatus, information processing method, and recording medium will be described. In the following, the fifth embodiment of the information processing apparatus, information processing method, and recording medium will be described using a gate apparatus 5 to which the fifth embodiment of the information processing apparatus, information processing method, and recording medium is applied.

### [5-1: Overview of the Gate Apparatus 5]

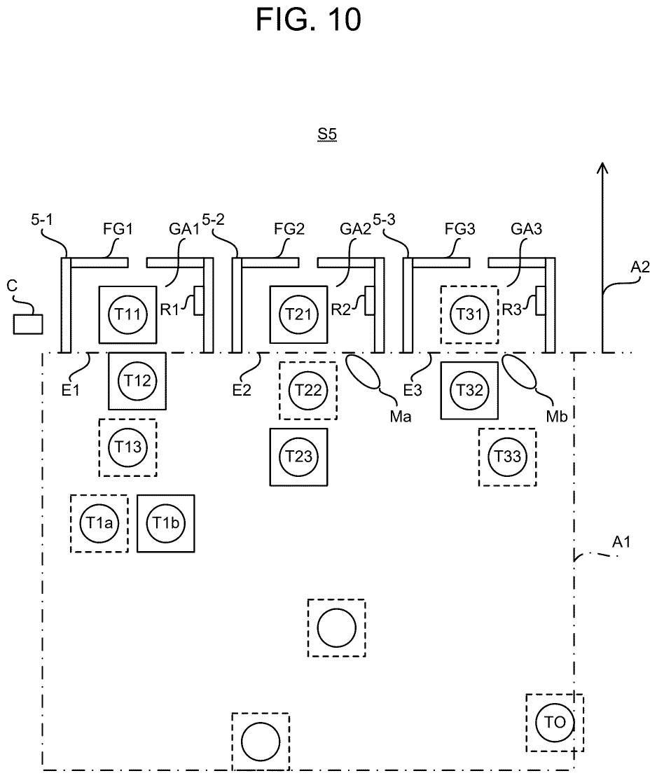

FIG. 10 is a conceptual diagram showing an application example of the information processing system S5 including the gate apparatus 5 according to the fifth embodiment. As shown in FIG. 10, the information processing system S5 includes a notification robot M (Ma, Mb in FIG. 10) as a mobile terminal. The notification robot M introduced in the fifth embodiment moves within the first area A1.

The notification robot M is equipped with an output apparatus. The output apparatus provided by the notification robot M may include a display. The notification robot M has, for example, a head and a body, and the head may include a display. The notification robot M may include a speaker. The notification robot M may notify the target person T of the recognition method by voice using a speaker capable of outputting sound in a directional manner.

### [5-2: Configuration of the Gate Apparatus 5]

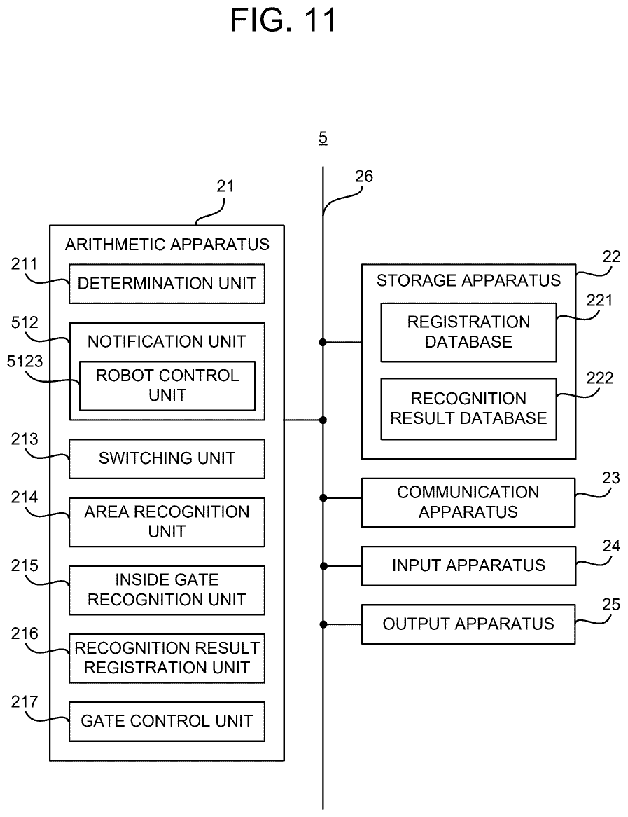

Referring to FIG. 11, the configuration of the gate apparatus 5 according to the fifth embodiment will be described. FIG. 11 is a block diagram showing the configuration of the gate apparatus 5 according to the fifth embodiment.

As shown in FIG. 11, the gate apparatus 5 according to the fifth embodiment differs from the gate apparatus 2 according to the second embodiment through the gate apparatus 4 according to the fourth embodiment in that a notification unit 512 includes a robot control unit 5123. The other features of the gate apparatus 4 may be the same as at least one other feature of the gate apparatus 2 through the gate apparatus 4. For this reason, the following describes in detail the parts that differ from the embodiments already described, and omits explanations of other overlapping parts as appropriate.

### [5-3: Information Processing Operation Performed by the Gate Apparatus 5]

The robot control unit 5123 displays the recognition method for the target person T determined by the determination unit 211 to the notification robot M moving within the first area A1, and notifies the target person T attempting to enter the gate area GA of the recognition method for the target person T. The robot control unit 5123 may move a notification robot M to approach the target person T2 in case the recognition method for the target person T1 differs from the recognition method for the target person T2.

In case the display D explained in the third embodiment is provided in the information processing system S5, and in case the recognition method for the target person T12 (or the target person T22, the target person T32) is different from the recognition method for the target person T13 (or the target person T23, the target person T33) are different, the robot control unit 5123 may control the notification robot M to move closer to the target person T13 (or the target person T23, the target person T22). In this case, the target person T13 (or the target person T23, the target person T33) may be notified of the recognition method again from the display D at the entrance E. For example, the robot control unit 5123 may move the notification robot M to a location where it is easily visible to the target person T who is lined up second or later from the entrance E in the gate area GA and whose recognition mode differs from that of the preceding the target.

The notification robot M may be remotely operated online. The notification robot M may function as a proxy for an operator remotely controlling it online. The operator may control the notification robot M while confirming the screen S as illustrated in FIG. 9. In response to the operator's control, the robot control unit 5123 may control the notification robot M.

In case an operator attempts to notify the target person T on their own, one operator can only notify one target person T. However, in case one operator can operate a plurality of the notification robots M, they can notify a plurality of the target persons T simultaneously.

### [5-4: Technical Effect of the Gate Apparatus 5]

The gate apparatus 5 according to the fifth embodiment notifies by the output of a mobile body that can approach the target person, so the target person can recognize his/her own recognition method.

### 6: Sixth Example Embodiment

Next, the sixth embodiment of the information processing apparatus, information processing method, and recording medium will be described. In the following, the sixth embodiment of the information processing apparatus, information processing method, and recording medium will be described using a gate apparatus 6 to which the sixth embodiment of the information processing apparatus, information processing method, and recording medium is applied.

### [6-1: Configuration of the Gate Apparatus 6]

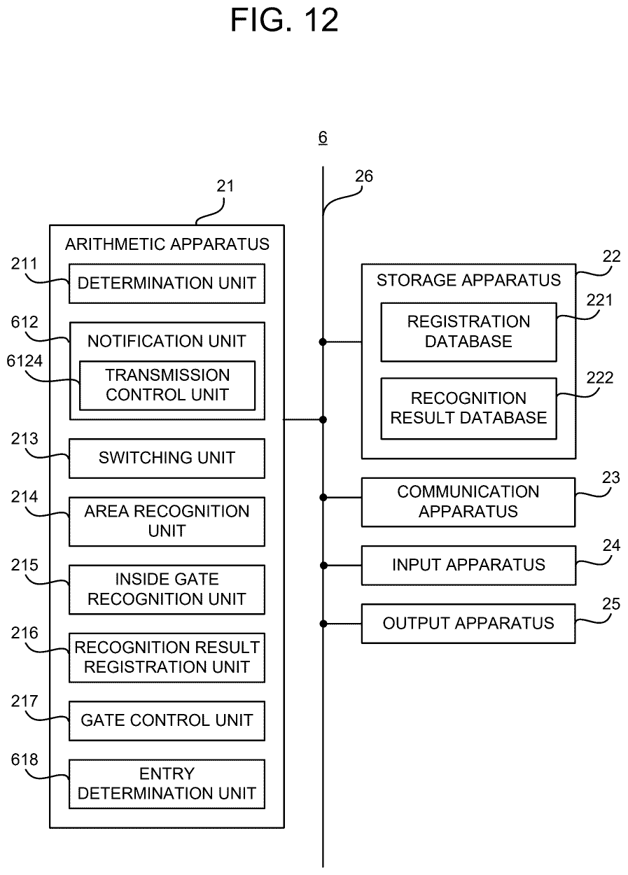

As shown in FIG. 12, the gate apparatus 6 according to the sixth embodiment differs from the gate apparatus 2 according to the second embodiment through the gate apparatus 5 according to the fifth embodiment is provided with an entry determination unit 618 within the arithmetic apparatus 21, and a notification unit 612 includes a transmission control unit 6124. Other features of the gate apparatus 6 may be the same as at least one other feature of the gate apparatus 2 through the gate apparatus 5. For this reason, the following description will explain in detail the parts that differ from the embodiments already described, and omit explanations of other overlapping parts as appropriate.

### [6-2: Information Processing Operations Performed by the Gate Apparatus 6]

The transmission control unit 6124 transmits information indicating the recognition method for the target person T determined by the determination unit 211 to an information processing terminal carried by the target person T before entering the gate area GA. The transmission control unit 6124 may send information indicating the recognition method for the target person T determined by the determination unit 211 to the information processing terminal carried by the target person T in case the target person T successfully performs area recognition.

Alternatively, the entry determination unit 618 determines that the target person T is lined up at the entrance E of the second area A2. The transmission control unit 6124 may transmit information indicating the recognition method for the target person T determined by the determination unit 211 to the information processing terminal carried by the target person T in case it is determined that the target person T is lined up at the entrance E of the second area A2.

Note that the target person T to whom information indicating the recognition method is transmitted to the information processing terminal carried by the target person T may be limited to persons who have successfully undergone area recognition, been identified as individuals, and had their contact information identified.

### [6-3: Technical Effect of the Gate Apparatus 6]

The gate apparatus 6 according to the sixth embodiment is capable of recognizing its own recognition method by notification to the information processing terminal carried by the target person T. The gate apparatus 6 is capable of notifying the target person T of the recognition method at an appropriate timing.

### 7: Supplementary Note

The following supplementary note is disclosed regarding the embodiments described above.

### [Supplementary Note 1]

An information processing apparatus including:
a determination unit that determines a recognition method for a target in case of entering a second area adjacent to a first area, depending on whether a first biometric recognition using biometric information acquired from an image of the target in the first area is successful or not; and
a notification unit that notifies the target before entering the second area of the recognition method for the target determined by the determination unit.

### [Supplementary Note 2]

The information processing apparatus according to Supplementary Note 1, further including
a switching unit that switches between a plurality of recognition modes based on the recognition method determined, wherein
the switching unit determines whether or not the recognition mode needs to be switched based on the recognition mode that is set and the recognition method for the target, and
the notification unit determines a manner of notification based on the determined whether or not the recognition mode needs to be switched.

### [Supplementary Note 3]

The information processing apparatus according to Supplementary Note 2, wherein
the switching unit does not switch the recognition mode in case the recognition mode that is set and a target recognition mode corresponding to the recognition method for the target are same, and switches the recognition mode in case the recognition mode that is set is different from the target recognition mode corresponding to the recognition method for the target, and
the notification unit emphasizes the notification in case the switching unit switches the recognition mode compared to in case the switching unit does not switch the recognition mode.

### [Supplementary Note 4]

The information processing apparatus according to Supplementary Note 2 or 3, wherein
the recognition method includes a second biometric recognition that recognizes the target using biometric information of the target, and a non-biometric recognition that recognizes the target using recognition information of the target other than the biometric information of the target,
in case the first biometric recognition of the target in the first area is successful, the target is recognized by the second biometric recognition in case entering the second area, and
in case the first biometric recognition of the target in the first area is not successful, the target is recognized by the non-biometric recognition in case entering the second area.

### [Supplementary Note 5]

The information processing apparatus according to Supplementary Note 4, wherein
the switching unit: switches the biometric recognition mode to a non-biometric recognition mode in which recognition is performed by the non-biometric recognition, in case of a biometric recognition mode in which recognition is performed by the second biometric recognition and in case the target does not succeed in the first biometric recognition in the first area in case of entering the second area;
switches the non-biometric recognition mode to the biometric recognition mode, in case of the non-biometric recognition mode and in case the target succeeds in the first biometric recognition in the first area in case of entering the second area; and
the notification unit notifies the target before entering the second area of the recognition method for the target determined by the determination unit, in case the switching unit switches from one of the biometric recognition mode and the non-biometric recognition mode to the other in case the target enters the second area.

### [Supplementary Note 6]

The information processing apparatus according to Supplementary Note 1 or 2, wherein
the notification unit displays the recognition method for the target determined by the determination unit on a display provided at an entrance to the second area, and notifies the target of the recognition method for the target before entering the second area.

### [Supplementary Note 7]

The information processing apparatus according to Supplementary Note 1 or 2, wherein
the notification unit transmits to an employee in the first area information indicating the recognition method for the target determined by the determination unit before entering the second area.

### [Supplementary Note 8]

The information processing apparatus according to Supplementary Note 1 or 2, wherein
the notification unit outputs the recognition method for the target determined by the determination unit to a mobile object equipped with an output mechanism and moving within the first area, thereby notifying the target of the recognition method for the target before entering the second area.

### [Supplementary Note 9]

The information processing apparatus according to Supplementary Note 1 or 2, wherein
the notification unit transmits information indicating the recognition method for the target determined by the determination unit to an information processing terminal carried by the target before entering the second area.

### [Supplementary Note 10]

The information processing apparatus according to Supplementary Note 9, further comprising
an entrance determination unit that determines that the target is lining up at an entrance to the second area, and wherein
the notification unit transmits information indicating the recognition method for the target determined by the determination unit to the information processing terminal carried by the target, in case the entrance determination unit determines that the target is lining up at the entrance to the second area.

### [Supplementary Note 11]

An information processing method including:
determining a recognition method for a target in case of entering a second area adjacent to a first area, depending on whether a first biometric recognition using biometric information acquired from an image of the target in the first area is successful or not; and
notifying the target before entering the second area of the recognition method for the target determined.

### [Supplementary Note 12]

A recording medium on which a computer program is stored, the computer program being configured to allow a computer to execute an information processing method including:
determining a recognition method for a target in case of entering a second area adjacent to a first area, depending on whether a first biometric recognition using biometric information acquired from an image of the target in the first area is successful or not; and
notifying the target before entering the second area of the recognition method for the target determined.

This disclosure may be changed as appropriate within the scope that does not contradict the technical idea that can be read from the claims and the entire description. The information processing apparatus, information processing method, and recording medium with such changes are also included in the technical idea of this disclosure.

### DESCRIPTION OF REFERENCE CODES

1 information processing apparatus
2, 3, 4, 5, 6 gate apparatus
11, 211 determination unit
12, 212, 312, 412, 512, 612 notification unit
213 switching unit
214 area recognition unit
215 inside gate recognition unit
216 recognition result registration unit
217 gate control unit
221 registration database
222 recognition result database
3121 display control unit
4122 screen control unit
5123 robot control unit
6124 transmission control unit
618 entry determination unit

What is claimed is:

1. An information processing apparatus comprising:
at least one memory storing instructions; and
at least one processor that is configured to execute the instructions to:
determine a recognition method for a target in case of entering a second area adjacent to a first area, depending on whether a first biometric recognition using biometric information acquired from an image of the target in the first area is successful or not; and
notify the target before entering the second area of the recognition method for the target determined.

2. The information processing apparatus according to claim 1, the at least one processor that is configured to execute the instructions to:
switch between a plurality of recognition modes based on the recognition method determined;
determine whether or not the recognition mode needs to be switched based on the recognition mode that is set and the recognition method for the target; and
determine a manner of notification based on the determined whether or not the recognition mode needs to be switched.

3. The information processing apparatus according to claim 2, the at least one processor that is configured to execute the instructions to:
not switch the recognition mode in case the recognition mode that is set and a target recognition mode corresponding to the recognition method for the target are same;
switch the recognition mode in case the recognition mode that is set is different from the target recognition mode corresponding to the recognition method for the target; and
emphasize the notification in case the recognition mode is switched compared to in case the recognition mode is not switched.

4. The information processing apparatus according to claim 2, wherein
the recognition method includes a second biometric recognition that recognizes the target using biometric information of the target, and a non-biometric recognition that recognizes the target using recognition information of the target other than the biometric information of the target,
in case the first biometric recognition of the target in the first area is successful, the target is recognized by the second biometric recognition in case entering the second area, and
in case the first biometric recognition of the target in the first area is not successful, the target is recognized by the non-biometric recognition in case entering the second area.

5. The information processing apparatus according to claim 4, the at least one processor that is configured to execute the instructions to:
switch the biometric recognition mode to a non-biometric recognition mode in which recognition is performed by the non-biometric recognition, in case of a biometric recognition mode in which recognition is performed by the second biometric recognition and in case the target does not succeed in the first biometric recognition in the first area in case of entering the second area;
switch the non-biometric recognition mode to the biometric recognition mode, in case of the non-biometric recognition mode and in case the target succeeds in the first biometric recognition in the first area in case of entering the second area; and
notify the target before entering the second area of the recognition method for the target determined, in case of the biometric recognition mode and the non-biometric recognition mode are switched from one to the other in case the target enters the second area.

6. The information processing apparatus according to claim 1, the at least one processor that is configured to execute the instructions to:
display the recognition method for the target determined on a display provided at an entrance to the second area, and
notify the target of the recognition method for the target before entering the second area.

7. The information processing apparatus according to claim 1, the at least one processor that is configured to execute the instructions to
transmit to an employee in the first area information indicating the recognition method for the target determined before entering the second area.

8. The information processing apparatus according to claim 1, the at least one processor that is configured to execute the instructions to
output the recognition method for the target determined to a mobile object equipped with an output mechanism and moving within the first area, thereby notifying the target of the recognition method for the target before entering the second area.

9. The information processing apparatus according to claim 1, the at least one processor that is configured to execute the instructions to
transmit information indicating the recognition method for the target determined to an information processing terminal carried by the target before entering the second area.

10. The information processing apparatus according to claim 9, the at least one processor that is configured to execute the instructions to:
determine that the target is lining up at an entrance to the second area; and
transmit information indicating the recognition method for the target determined to the information processing terminal carried by the target, in case it is determined that the target is lining up at the entrance to the second area.

11. An information processing method comprising:
determining a recognition method for a target in case of entering a second area adjacent to a first area, depending on whether a first biometric recognition using biometric information acquired from an image of the target in the first area is successful or not; and
notifying the target before entering the second area of the recognition method for the target determined.

12. A non-transitory recording medium on which a computer program is stored, the computer program being configured to allow a computer to execute an information processing method comprising:
determining a recognition method for a target in case of entering a second area adjacent to a first area, depending on whether a first biometric recognition using biometric information acquired from an image of the target in the first area is successful or not; and
notifying the target before entering the second area of the recognition method for the target determined.
